(19) United States
(12) Patent Application Publication
(10) Pub. No.: US 2022/0391686 A1
(43) Pub. Date: Dec. 8, 2022

(54) DYNAMIC OBSTACLE AVOIDANCE DURING MEDIA CAPTURE

(71) Applicant: International Business Machines Corporation, Armonk, NY (US)

(72) Inventors: Clement Decrop, Arlington, VA (US); Sarbajit K. Rakshit, Kolkata (IN); James E. Bostick, Cedar Park, TX (US); Martin G. Keen, Cary, NC (US); John M. Ganci, JR., Raleigh, NC (US)

(21) Appl. No.: 17/337,490

(22) Filed: Jun. 3, 2021

(51) Int. Cl. G06N 3/08; G06F 16/55; G06K 9/00; G06K 9/62; G06F 40/30; G06T 7/70

(52) U.S. Cl. CPC G06N 3/08; G06F 16/55; G06K 9/00664; G06K 9/6267; G06F 40/30; G06T 7/70; G06K 9/6217; G06T 2207/30241; G06T 2207/20084

(57) ABSTRACT

Embodiments of the present invention provide computer-implemented methods, computer program products and computer systems. Embodiments of the present invention can predict that one or more objects affects media capture using one or more sensors of a media capture device. Embodiments of the present invention can then determine whether at least one object of the one or more objects is appropriate based, at least in part, on a comparison to an object database used to classify appropriateness for context. Embodiments of the present invention can then determine one or more corrective actions to avoid at least one object determined to be inappropriate from being within the media capture device's field of view.

### BACKGROUND

The present invention relates in general to dynamic obstacle avoidance and in particular to prediction, notification, and corrective action to avoid unintended objects in the field of view during media capture.

Typically, digital imaging or image acquisition is the creation of a representation of the visual characteristics of an object such as a physical scene or the interior structure of an object. This generally refers to or otherwise includes the processing, compression, storage, printing, and display of such images. A key advantage of a digital image, versus an analog image such as a film photograph, is the ability to digitally make copies and copies of copies indefinitely without any loss of image quality.

Images can be captured using one or more devices such as digital cameras having one or more image sensors. Digital cameras used to capture images and digital video cameras used to capture video often share an optical system. This optical system typically uses a lens with a variable diaphragm to focus light onto an image pickup device. The diaphragm and shutter admit the correct amount of light to the image, just as with film but the image pickup device is electronic rather than chemical. Unlike film cameras, digital cameras can display images on a screen immediately after being recorded, and store and delete images from memory. Many digital cameras can also record moving videos with sound. Some digital cameras can crop and stitch pictures and perform other elementary image editing.

### SUMMARY

According to an aspect of the present invention, there is provided a computer-implemented method. The computer implemented method comprises predicting that one or more objects affects media capture using one or more sensors of a media capture device; determining whether at least one object of the one or more objects is appropriate based, at least in part, on a comparison to an object database used to classify appropriateness for context; and determining one or more corrective actions to avoid at least one object determined to be inappropriate from being within the media capture device's field of view.

### BRIEF DESCRIPTION OF THE DRAWINGS

Preferred embodiments of the present invention will now be described, by way of example only, with reference to the following drawings, in which:

FIG. 1 depicts a block diagram of a computing environment, in accordance with an embodiment of the present invention;

FIG. 2 is a flowchart depicting operational steps preventing an unintended object being captured, in accordance with an embodiment of the present invention;

FIG. 3 is a flowchart depicting operational steps for determining whether an object is unintended, in accordance with an embodiment of the present invention; and

FIG. 4 is a block diagram of an example system, in accordance with an embodiment of the present invention.

### DETAILED DESCRIPTION

Embodiments of the present invention recognize limitations with image capturing systems (e.g., digital cameras). Specifically, embodiments of the present invention recognize that current systems are typically focused solely on image capture and cannot predict when an unintended object (e.g., an obstacle) comes into the field of view. For example, a user (e.g., a photographer) may intend to capture an image depicting a moment (e.g., a celebration) but as the user begins the image capture (e.g., takes the photograph), a vehicle enters the field of view (e.g., unintended object, also referred to as an obstacle) and obscures the celebration.

Embodiments of the present invention solve this problem by providing a proactive solution that can be implemented before an event occurs. As used herein, an “event” refers to a series of actions or movements that results in an unintended object, coming into the field of view of a camera at the time of a media capture, that is, a moment in time that a user captures an image or video recording. Examples of an event can include an object moving into a camera's field of view which results in being unintentionally captured or otherwise featured a camera's field of view during a media capture moment. More specifically, an event can include moments where a car, bus, balloon, chair, etc. come into the camera's field of view and is unintentionally captured. An event can also include instances when living things such as animals and people are unintentionally captured. Broadly speaking, an unintended object can thus refer to any inanimate article or living being.

Embodiments of the present invention provide a proactive solution by predicting that an object will come into the camera's field of view, predicting a time in which that object will come into the camera's field of view, and take proactive measures to ensure that the object will be avoided during media capture. For example, some embodiments of the present invention can, in response to predicting that an object will come into the camera's field of view as well as the time in which that object will come into the camera's field of view, transmit a notification to a user advising the user of its prediction. Other embodiments of the present invention recommend a series of actions a user can take to avoid the unintended object (e.g., recommending a pause, angle change, alternate media capture, recommended movement, etc.).

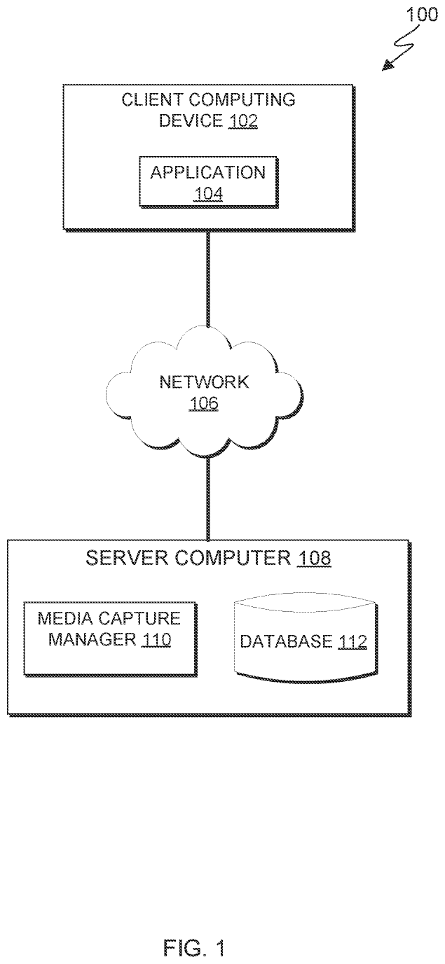

FIG. 1 is a functional block diagram illustrating a computing environment, generally designated, computing environment 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

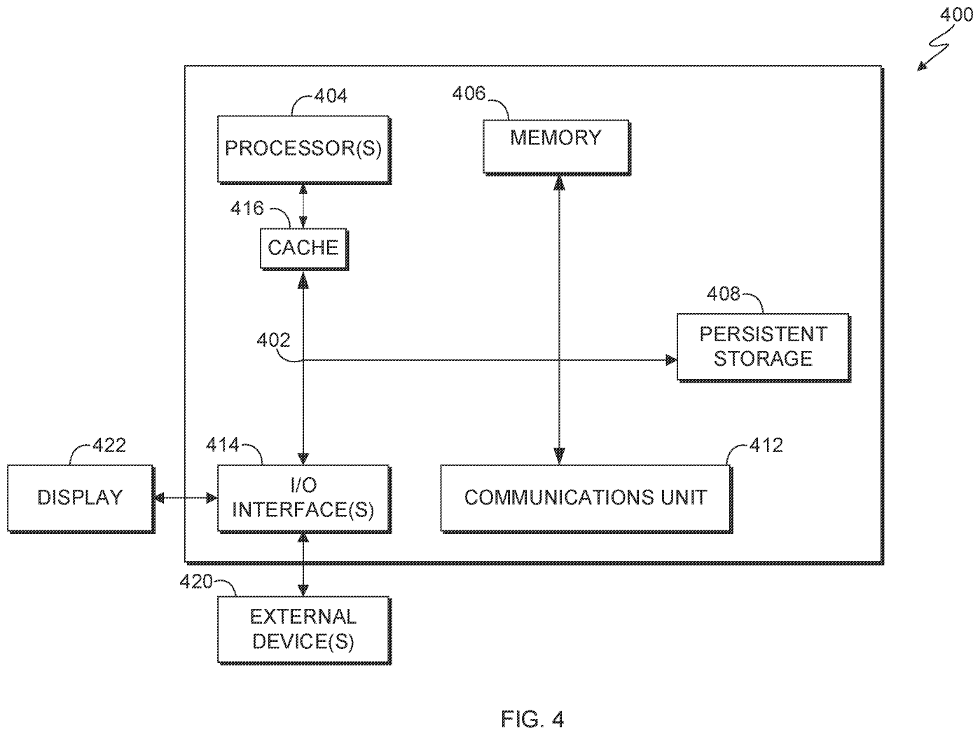

Computing environment 100 includes client computing device 102 and server computer 108, all interconnected over network 106. Client computing device 102 and server computer 108 can be a standalone computer device, a management server, a webserver, a mobile computing device, or any other electronic device or computing system capable of receiving, sending, and processing data. In other embodiments, client computing device 102 and server computer 108 can represent a server computing system utilizing multiple computer as a server system, such as in a cloud computing environment. In another embodiment, client computing device 102 and server computer 108 can be a laptop computer, a tablet computer, a netbook computer, a personal computer (PC), a desktop computer, a personal digital assistance (PDA), a smart phone, or any programmable electronic device capable of communicating with various components and other computing devices (not shown) within computing environment 100. In another embodiment, client computing device 102 and server computer 108 each represent a computing system utilizing clustered computers and components (e.g., database server computers, application server computers, etc.) that act as a single pool of seamless resources when accessed within computing environment 100. In some embodiments, client computing device 102 and server computer 108 are a single device. Client computing device 102 and server computer 108 may include internal and external hardware components capable of executing machine-readable program instructions, as depicted and described in further detail with respect to FIG. 4.

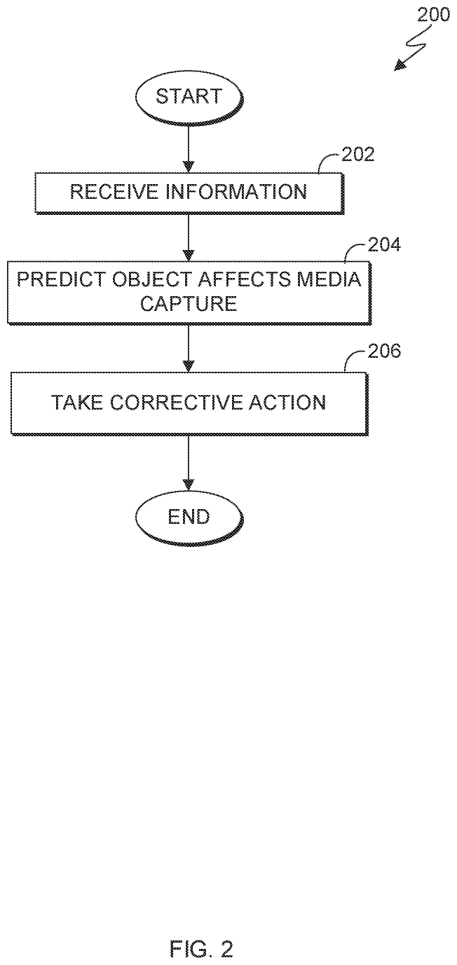

In this embodiment, client computing device 102 is a user device associated with a user and includes application 104. Application 104 communicates with server computer 108 to access media capture manager 110 (e.g., using TCP/IP) to access content, user information, and database information. Application 104 can further communicate with media capture manager 110 to transmit instructions to detect events, identify potential causes for the detected events, and create visual simulations of the detected events comprising one or more graphic icon overlays indicating potential causes and potential portions of the user that may be injured. Specifically, embodiments of the present invention increase security by utilizing the immutable nature of blockchain at several levels as discussed in greater detail with regard to FIGS. 2-4.

Network 106 can be, for example, a telecommunications network, a local area network (LAN), a wide area network (WAN), such as the Internet, or a combination of the three, and can include wired, wireless, or fiber optic connections. Network 106 can include one or more wired and/or wireless networks that are capable of receiving and transmitting data, voice, and/or video signals, including multimedia signals that include voice, data, and video information. In general, network 106 can be any combination of connections and protocols that will support communications among client computing device 102 and server computer 108, and other computing devices (not shown) within computing environment 100.

Server computer 108 is a digital device that hosts media capture manager 110 and database 112. In this embodiment, media capture manager 110 resides on server computer 108. In other embodiments, media capture manager 110 can have an instance of the program (not shown) stored locally on client computer device 102. In other embodiments, media capture manager 110 can be a standalone program or system that predicts whether unintended objects will come into a camera's field of view before a media capture and takes appropriate corrective action as discussed in greater detail below. In yet other embodiments, media capture manager 110 can be stored on any number or computing devices.

Media capture manager 110 predicts whether unintended objects will come into a camera's field of view before a media capture and takes appropriate corrective action. In this embodiment, media capture manager 110 can be a part of a camera device having one or more sensors (e.g., ultrasound, proximity, infrared, etc.) to detect objects and have network capabilities (e.g., 4G, 5G, Wi-Fi, etc.). In some embodiments, media capture manager 110 can access a cognitive system to predict objects moving into the camera's field of view, determine whether the objects are appropriate or unintended, and to determine corrective actions to avoid the object coming into the camera's field of view.

Media capture manager 110 can be configured to receive user information. User information can include one or more user profiles. In this embodiment, a user profile can include device information (e.g., hardware information associated with a camera, device capabilities, etc.) and user preferences (e.g., image quality, raw recording, white balance, picture control/picture style/creative style/film simulation, color space, long exposure noise reduction, High ISO noise Reduction, Active D-lighting/DRO, HDR, Lens corrections (e.g., vignette control, chromatic aberration control, distortion control, etc.), etc.).

User information can also include access to user defined objects stored on a database. Media capture manager 110 can also store and access previously learned objects and context associated with learned objects. For example, user information can include object recognition for cars and associated context. For example, media capture manager 110 can learn varying contexts for objects. Specifically, in instances when the focus of the media capture is a car, media manager 110 can identify the car and ignore predictions that the car will come into focus (e.g., when a photographer is capturing the image of the car on a track). Instead, media capture manager 110 can transmit a notification when it is appropriate to capture the image of the car (to capture or otherwise depict movement of the car). Conversely, when the car is not the focus of the media capture, media capture manager 110 can learn that context and thus transmit a notification that the car will come into the camera's field of view and transmit one or more recommendations to the user to avoid capturing the car. Media capture manager 110 can store this received user information as part of a database (e.g., object database such as database 112) and reference the database to classify appropriateness for context as discussed in greater detail later in this specification. In certain other embodiments, media capture manager 110 can take automatically take appropriate action without user intervention.

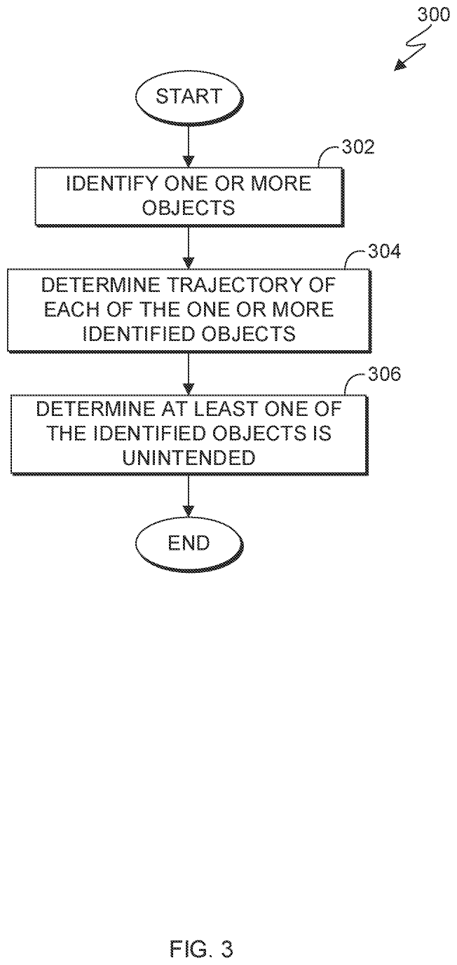

In response to a user request to start media capture (e.g., image or video), media capture manager 110 predicts whether detected objects will come into the camera's field of view (e.g., within a certain proximity to the camera's field of view). In this embodiment, media capture manager 110 predicts whether detected objects will come into the camera's field of view utilizing one or more proximity and ultrasound sensors to determine mobility of an object and calculate potential trajectories of the object as discussed in greater detail with respect to FIGS. 2 and 3.

In this embodiment, in response to predicting that the detected object will come into the camera's field of view, media capture manager 110 determines the appropriateness of the detected object. As used herein, “appropriateness” refers to whether the object an intended or unintended article that will be captured during a media capture moment. For example, a user can configure media capture manager 110 to recognize the subject of a media capture moment to be a celebration. Specifically, a user can specify that the subjects of the media capture moment would be of a bride and groom. Thus, media capture manager 110 can recognize the context as “celebration” and the subjects as two users (e.g., bride and groom) and thus determine that any object that comes into the camera's field of view that is not the bride and groom is not appropriate (i.e., unintended).

Media capture manager 110 can determine appropriateness in several different ways. For example, in one embodiment, media capture manager 110 can determine appropriateness based on user preferences. For example, a user can define preferences for objects the user identifies as unintended or obstacles not to be featured within a camera's field of view.

In another embodiment, media capture manager 110 can determine appropriateness based on learned context. For example, with each media capture moment, media capture manager 110 can associate different user selections and learn which objects are deemed as intended or not intended. In this embodiment, media capture manager 110 can use a combination of machine learning algorithms to learn user selections.

In yet another embodiment, media capture manager 110 can determine appropriateness based on learned event context. For example, media capture manager 110 can utilize location awareness to derive context of a media capture moment (e.g., a graduation hall, a sports stadium, event space, etc.). Media capture manager 110 can then detect one or more objects within the location as appropriate based on the identified location. For example, in instances where media capture manager 110 identifies the location as an event space such as a hotel, media capture manager 110 can identify a number of objects as appropriate (e.g., one or more people, furniture, pool, landscape, etc.). In another example, in an instance where media capture manager 110 identifies the location as a raceway, media capture manager 110 can identify cars as appropriate objects. In this embodiment, media capture manager 110 can identify a primary car and one or more secondary cars as appropriate objects.

In yet another embodiment, media capture manager 110 can determine appropriateness based on script integration. For example, in instances where a script is available for a desired video, media capture manager 110 can utilize a combination of natural language processing algorithms to define what objects will be determined as appropriate. Accordingly, media capture manager 110 can detect objects in the field of view and utilizes a Convolutional Neural Network (CNN) image classifier to detect wither or not an object is appropriate.

Media capture manager 110 can then, in response to determining that an object is unintended take a number of corrective actions (also referenced as an ameliorative action). In this embodiment, media capture manager 110 can transmit a notification and one or more recommendations. For example, media capture manager 110 can generate a notification detailing the detected, unintended object. Media capture manager 110 can display the generated notification on a display of the media capture device (e.g., a display of the camera, mobile device, etc.). In this embodiment, media capture manager 110 can proactively display the notification on the device so the user can take action (e.g., accept the notification or reject the notification).

In this embodiment, media capture manager 110 supplement the notification with one or more other corrective actions. In this embodiment, a corrective action refers to a recommendation that comprises one or more actions taken either by the user or media capture manager 110 to avoid the detected, unintended object. For example, media capture manager 110 can transmit a recommendation to pause in addition to the notification. For example, media capture manager 110 can, in addition to the notification of the detected, unintended object, transmit a recommendation to wait until the detected object has passed before taking the image capturing moment.

In another example, media capture manager 110 can transmit a recommendation to move. The recommendation to move can include recommendations to change camera angles to remove the detected object from the field of view. In certain other embodiments, media capture manager 110 can transmit alternate locations that satisfies user preferences (e.g., exposure, lighting, etc.) to capture the intended object in a manner that removes the unintended object from the camera's field of view.

In yet another example, where media capture manager 110 is utilized with one or more capture devices (e.g., one or more cameras), media capture manager 110 can suggest alternate cameras to capture the image or video. For example, when camera A is predicted to have obstruction, media capture manager 110 can source media capture from camera B which is another user sharing video stream from different field of view.

In some embodiments, media capture manager 110 can be configured to work with other media capture devices. For example, media capture manager 110 can interface with mobile media capture devices (e.g., drones). In these embodiments, media capture manager 110 can take ameliorative action (also referenced as a corrective action) by transmitting instructions to and initiate movement of those mobile media capture devices. For example, media capture manager 110 can manage one or more mobile media capture devices (e.g., a drone having camera A). In this example, media capture manager 110 can identify that camera A is predicted to have obstruction, media capture manager 110 can then transmit instructions to move and subsequently position the drone with camera A to another location or angle such that camera A has a field of view free of the obstruction for media capture. In instances where media capture manager 110 is managing more than one mobile media capture devices (e.g., drones), media capture manager 110 can transmit instructions to move along with GPS coordinates to move respective mobile media capture devices (e.g., drones).

Media capture manager 110 improves with each media capture using specific user specific feedback. For example, in some embodiments, a user can provide feedback with respect to a user's reaction to the detected object moving into frame. A user can also provide feedback with respect to a user's reaction to recommendations and predictions of media capture manager 110.

Database 112 stores received information and can be representative of one or more databases that give permissioned access to media capture manager 110 or publicly available databases. For example, database 112 can store received user biometrics and created visual simulations. In general, database 112 can be implemented using any non-volatile storage media known in the art. For example, database 112 can be implemented with a tape library, optical library, one or more independent hard disk drives, or multiple hard disk drives in a redundant array of independent disk (RAID). In this embodiment database 112 is stored on server computer 108.

FIG. 2 is a flowchart 200 depicting operational steps preventing an unintended object being captured, in accordance with an embodiment of the present invention.

In step 202, media capture manager 110 receives information. In this embodiment, media capture manager 110 receives a request from client computing device 102 to register for the services of media capture manager 110. For example, media capture manager 110 can receive requests from one or more media capture devices (e.g., cameras, camera devices, etc.). In other embodiments, media capture manager 110 can receive information from one or more other components of computing environment 100.

In step 204, media capture manager 110 predicts objects that affects media capture. In this embodiment, media capture manager 110 predicts objects that affects media capture by identifying one or more objects, determining trajectory of each of the one or more identified objects, and determining that at least one of the identified objects is unintended as described in greater detail with respect to FIG. 3. For example, media capture manager 110 can, in certain circumstances, determine context associated with a media capture moment and determine whether objects are intended or unintended for the camera's field of view.

In step 206, media capture manager 110 takes corrective action. In this embodiment, media capture manager 110 takes corrective action by generating a notification and one or more recommendations.

In this embodiment, the media capture manager 110 can generate a notification comprising one or more unintended objects, reasons for the designation as unintended objects, times in which the unintended objects may come into the camera's field of view, and trajectories associated with respective unintended objects. Media capture manager 110 can display the generated notification on a display of the media capture device (e.g., a display of the camera, mobile device, etc.). As mentioned above, media capture manager 110 can proactively display the notification on the device so the user can take action (e.g., accept the notification or reject the notification).

In this embodiment, media capture manager 110 supplement the notification with one or more recommendations. Examples of recommendations can include one or more actions either a user or media capture manager 110 can perform to either remove the unintended object from the camera's field of view or prevent (i.e., avoid) the unintended object from being captured within the camera's field of view during a media capture event. Specifically, media capture manager 110 can, in addition to the notification of the detected, unintended object, transmit a recommendation to pause or otherwise delay media capture until the detected object has passed before taking the image capturing moment. Depending on the identified contextual situation, media capture manager 110 may transmit a recommendation or otherwise automatically perform media capture at such time that the detected object, classified as intended (e.g., in instances where the photograph requirement is to capture a car in motion), passed within the camera's field of view.

Other examples of recommendations can be recommendations to move and subsequently execute at least one of those recommendations automatically. In this embodiment, recommendations to move can include recommendations to change camera angles, move to alternate locations that satisfy user requirements (e.g., user photograph settings, user image capturing preferences, etc.). Other examples of recommendations can further include modifying media capture device (e.g., adding or removing hardware and/or changing user camera settings).

In scenarios where media capture manager 110 is utilized with one or more capture devices (e.g., one or more cameras), media capture manager 110 can suggest alternate cameras to capture the image or video. For example, when camera A is predicted to have obstruction, media capture manager 110 can source media capture from camera B which is another user sharing video stream from different field of view. In some embodiments, these recommendations may be performed automatically by media capture manager 110.

Regardless of action taken by media capture manager 110, media capture manager 110 stores actions taken (e.g., done automatically by media capture manager 110 or selected manually by a user) and context information collected (e.g., subjects of media capture, angles used, camera settings, etc.) with the media capture (e.g., photo, video, etc.). For example, in this embodiment, media capture manager 110 can store the actions taken, context information, along with the media capture in database 112. In this manner, media capture manager 110 can improve using historical analysis and machine learning algorithms for future media capture requests. In other embodiments, media capture manager 110 can store the actions taken and context on one or more other components of computing environment 100. For example, in some embodiments, media capture manager 110 can store actions taken and context locally on a media capture device.

FIG. 3 is a flowchart 300 depicting operational steps for determining whether an object is unintended, in accordance with an embodiment of the present invention.

In step 302, media capture manager 110 identifies one or more objects. In this embodiment, media capture manager 110 identifies one or more objects using one or more object recognition algorithms. For example, media capture manager 110 can identify one or more objects using a combination of one or more sensors of the media capture device and then feed the identified one or more objects through an object recognition algorithm to identify what the object is (e.g., to determine that the detected object is a car).

In step 304, media capture manager 110 determines trajectory of each of the one or more identified objects. In this embodiment, media capture manager 110 determines the trajectory of each of the one or more identified objects using one or more trajectory prediction algorithms. In other embodiments, media capture manager 110 can utilize an artificial intelligence system to predict trajectory of moving objects.

In another embodiment, media capture manager 110 can determine trajectory of each of the one or more identified objects by plotting one or more paths associated with the object based on observed or otherwise detected movement. Media capture 110 can then determine an object to be an obstacle if the identified object's trajectory and subsequent movement places it within a threshold distance (e.g., proximity) to the media capture device. For example, media capture manager 110 can determine the trajectory of the identified object as intersecting with the camera's field of view. Subsequently, media capture manager 110 can flag or otherwise designate the identified object as a potential obstacle when the identified object reaches a certain radius around the media capture device.

In step 306, media capture manager 110 determines at least one of the identified objects is unintended. In this embodiment, media capture manager 110 determines at least one of the identified objects is unintended based, at least in part on context associated with the media capture. In some embodiments, context is based solely on user preference. In other embodiments, context is based on learned user feedback (e.g., utilizing user's previous selections associated with previous media capture). In yet other embodiments, media capture manager 110 can identify context based on an identified location.

Finally, in yet other embodiments, media capture manager 110 can learn context based on script integration. For example, media capture manager 110 can run a script and utilize natural language processing techniques and natural language classification techniques to define what objects should remain in the camera's field of view. As used herein, a script can be a broad set of defined terms whereby particular objects are weighted considering absolute and relative relevancy in frame. A script can also be a series of instructions or a narrative (i.e., objects moving into frame and not consistent with the written instructions can be considered an obstacle. In some embodiments, a script can also reference a set of service level agreements (SLAs). For example, a security camera is required to capture all vehicles within a defined area of its field of view but ignore maintenance vehicles and other known, registered vehicles in other fields of view. Media capture manager 110 can then use a CNN image classifier to detect whether an object is desired in the media capture.

In some embodiments, where media capture manager 110 uses script integration (i.e., to derive if objects detected with a predicted path into the field of view should be considered as obstacles), media capture manager 110 can determine appropriateness using absolute and relative relevancy. As used herein “absolute relevancy” in frame refers to an object as always rated as an obstacle or non-obstacle in a set contextual situation. For example, media capture manager 110 can automatically determine the presence of a person appearing in frame as relevant (i.e., appropriate) if they are a family member and an obstacle if they are not. As used herein “relative relevancy” in frame refers to appropriateness (i.e., relevancy) being contingent on a relationship with other objects in frame. For example, where in a racing event, media capture manager can determine car 3 as relevant (e.g., appropriate), when car 3 is in contention for winning a lap but is considered an obstacle when it is being lapped.

FIG. 4 depicts a block diagram of components of computing systems within computing environment 100 of FIG. 1, in accordance with an embodiment of the present invention. It should be appreciated that FIG. 4 provides only an illustration of one implementation and does not imply any limitations with regard to the environments in which different embodiments can be implemented. Many modifications to the depicted environment can be made.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Computer system 400 includes communications fabric 402, which provides communications between cache 416, memory 406, persistent storage 408, communications unit 412, and input/output (I/O) interface(s) 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses or a crossbar switch.

Memory 406 and persistent storage 408 are computer readable storage media. In this embodiment, memory 406 includes random access memory (RAM). In general, memory 406 can include any suitable volatile or non-volatile computer readable storage media. Cache 416 is a fast memory that enhances the performance of computer processor(s) 404 by holding recently accessed data, and data near accessed data, from memory 406.

Media capture manager 110 (not shown) may be stored in persistent storage 408 and in memory 606 for execution by one or more of the respective computer processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 412, in these examples, provides for communications with other data processing systems or devices. In these examples, communications unit 412 includes one or more network interface cards. Communications unit 412 may provide communications through the use of either or both physical and wireless communications links. Media capture manager 110 may be downloaded to persistent storage 508 through communications unit 412.

I/O interface(s) 414 allows for input and output of data with other devices that may be connected to client computing device and/or server computer. For example, I/O interface 414 may provide a connection to external devices 420 such as a keyboard, keypad, a touch screen, and/or some other suitable input device. External devices 420 can also include portable computer readable storage media such as, for example, thumb drives, portable optical or magnetic disks, and memory cards. Software and data used to practice embodiments of the present invention, e.g., media capture manager 110, can be stored on such portable computer readable storage media and can be loaded onto persistent storage 408 via I/O interface(s) 414. I/O interface(s) 414 also connect to a display 422.

Display 422 provides a mechanism to display data to a user and may be, for example, a computer monitor.

The present invention may be a system, a method, and/or a computer program product. The computer program product may include a computer readable storage medium (or media) having computer readable program instructions thereon for causing a processor to carry out aspects of the present invention.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
predicting that one or more objects affects media capture using one or more sensors of a media capture device;
determining whether at least one object of the one or more objects is appropriate based, at least in part, on a comparison to an object database used to classify appropriateness for context; and
determining one or more corrective actions to avoid the at least one object determined to be inappropriate from being within the media capture device's field of view.

2. The computer-implemented method of claim 1, wherein determining whether at least one object of the one or more objects is appropriate based on a comparison to an object database used to classify appropriateness for context comprises:
identifying objects within a predicted path into the media capture device's field of view as inappropriate using script analysis based on absolute relevancy in frame and relative relevancy in frame.

3. The computer-implemented method of claim 2, further comprising:
using natural language processing and natural language classification in the script analysis.

4. The computer-implemented method of claim 1, wherein the one or more sensors of the media capture device includes ultrasound sensors, proximity sensors, and infrared sensors.

5. The computer-implemented method of claim 1, wherein determining whether at least one object of the one or more objects is appropriate based, at least in part, on a comparison to an object database used to classify appropriateness for context comprises:
identifying one or more objects using a convolutional neural network within proximity of the media capture device;
determining trajectories of each of the one or more identified objects within the proximity of the media capture device; and
determining that at least one of the identified objects along a predicted trajectory that intersects with the media capture device's field of view is unintended.

6. The computer-implemented method of claim 1, wherein determining one or more corrective actions to avoid at least one object determined to be inappropriate from being within the media capture device's field of view comprises:
generating a notification detailing a trajectory associated with the object determined to be inappropriate; and
generating one or more recommendations to avoid at least one object determined to be inappropriate from being within the media capture device's field of view.

7. The computer-implemented method of claim 6, further comprising:
executing at least one of the generated one or more recommendations automatically.

8. A computer program product comprising:
one or more computer readable storage media and program instructions stored on the one or more computer readable storage media, the program instructions comprising:
program instructions to predict that one or more objects affects media capture using one or more sensors of a media capture device;
program instructions to determine whether at least one object of the one or more objects is appropriate based, at least in part, on a comparison to an object database used to classify appropriateness for context; and
program instructions to determine one or more corrective actions to avoid the at least one object determined to be inappropriate from being within the media capture device's field of view.

9. The computer program product of claim 8, wherein determining the program instructions to whether at least one object of the one or more objects is appropriate based on a comparison to an object database used to classify appropriateness for context comprise:
program instructions to identify objects within a predicted path into the media capture device's field of view as inappropriate using script analysis based on absolute relevancy in frame and relative relevancy in frame.

10. The computer program product of claim 9, wherein the program instructions stored on the one or more computer readable storage media further comprise:
program instructions to use natural language processing and natural language classification in the script analysis.

11. The computer program product of claim 8, wherein the one or more sensors of the media capture device includes ultrasound sensors, proximity sensors, and infrared sensors.

12. The computer program product of claim 8, wherein the program instructions to determine whether at least one object of the one or more objects is appropriate based, at least in part, on a comparison to an object database used to classify appropriateness for context comprise:
program instructions to identify one or more objects using a convolutional neural network within proximity of the media capture device;
program instructions to determine trajectories of each of the one or more identified objects within the proximity of the media capture device; and
program instructions to determine that at least one of the identified objects along a predicted trajectory that intersects with the media capture device's field of view is unintended.

13. The computer program product of claim 8, wherein the program instructions to determine one or more corrective actions to avoid at least one object determined to be inappropriate from being within the media capture device's field of view comprise:
program instructions to generate a notification detailing a trajectory associated with the object determined to be inappropriate; and
program instructions to generate one or more recommendations to avoid at least one object determined to be inappropriate from being within the media capture device's field of view.

14. The computer program product of claim 13, wherein the program instructions stored on the one or more computer readable storage media further comprise:
program instructions to execute at least one of the generated one or more recommendations automatically.

15. A computer system comprising:
one or more computer processors;
one or more computer readable storage media; and
program instructions stored on the one or more computer readable storage media for execution by at least one of the one or more computer processors, the program instructions comprising:
program instructions to predict that one or more objects affects media capture using one or more sensors of a media capture device;
program instructions to determine whether at least one object of the one or more objects is appropriate based, at least in part, on a comparison to an object database used to classify appropriateness for context; and
program instructions to determine one or more corrective actions to avoid the at least one object determined to be inappropriate from being within the media capture device's field of view.

16. The computer system of claim 15, wherein determining the program instructions to whether at least one object of the one or more objects is appropriate based on a comparison to an object database used to classify appropriateness for context comprise:
program instructions to identify objects within a predicted path into the media capture device's field of view as inappropriate using script analysis based on absolute relevancy in frame and relative relevancy in frame.

17. The computer system of claim 16, wherein the program instructions stored on the one or more computer readable storage media further comprise:
program instructions to use natural language processing and natural language classification in the script analysis.

18. The computer system of claim 15, wherein the one or more sensors of the media capture device includes ultrasound sensors, proximity sensors, and infrared sensors.

19. The computer system of claim 15, wherein the program instructions to determine whether at least one object of the one or more objects is appropriate based, at least in part, on a comparison to an object database used to classify appropriateness for context comprise:
program instructions to identify one or more objects using a convolutional neural network within proximity of the media capture device;
program instructions to determine trajectories of each of the one or more identified objects within the proximity of the media capture device; and
program instructions to determine that at least one of the identified objects along a predicted trajectory that intersects with the media capture device's field of view is unintended.

20. The computer system of claim 15, wherein the program instructions to determine one or more corrective actions to avoid at least one object determined to be inappropriate from being within the media capture device's field of view comprise:
program instructions to generate a notification detailing a trajectory associated with the object determined to be inappropriate; and
program instructions to generate one or more recommendations to avoid at least one object determined to be inappropriate from being within the media capture device's field of view
